(19) United States
(12) Patent Application Publication
(10) Pub. No.: US 2018/0215521 A1
(43) Pub. Date: Aug. 2, 2018

(54) CLOSURE DEVICE, METHOD OF MANUFACTURING A CLOSURE DEVICE AND A PACKAGING CONTAINER HAVING SUCH CLOSURE DEVICE

(71) Applicant: TETRA LAVAL HOLDINGS & FINANCE S.A., Pully (CH)

(72) Inventors: Bengt HÅKANSSON, Sjöbo (SE); Jens PERSSON, Bunkeflostrand (SE)

(73) Assignee: TETRA LAVAL HOLDINGS & FINANCE S.A., Pully, OT (CH)

(21) Appl. No.: 15/320,045

(22) PCT Filed: Apr. 22, 2015
(86) PCT No.: PCT/EP2015/058620

§ 371 Date: Dec. 19, 2016

(30) Foreign Application Priority Data
Jun. 19, 2014 (SE) 1450773-5
Jun. 19, 2014 (SE) 1450774-3

(51) Int. Cl. B65D 75/58; B65D 85/72; B65B 9/08; B65B 51/26; B65B 61/18; B65D 75/48; B31B 70/81

(52) U.S. Cl. CPC B65D 75/5822; B65D 85/72; B65B 9/08; B65B 51/26; B29C 45/14336; B65D 75/48; B31B 70/8131; B65D 2575/586; B65B 61/188

(57) ABSTRACT

A closure device for re-closing an opening on a packaging container, which opening having been initially opened within an opening area. The closure device comprises at least a first closure device part arranged on a first side of a first fold axis of the packaging container, and at least a second closure device part arranged on a second side of the first fold axis. The first closure device part is arranged between the opening area and the first fold axis. Further, the first and second closure device parts are provided with mutual lockable members such that the first and second closure device parts may be releasably locked to each other upon folding the packaging container along the first fold axis thereby re-closing the opening in the packaging container. Also, disclosed is a packaging container with a closure device as well as a method of manufacturing the packaging container.

### TECHNICAL FIELD

Described herein are a closure device, a method of manufacturing a closure device and a packaging container for liquid or semi-liquid food, said packaging container having a closure device.

### BACKGROUND OF THE INVENTION

Packaging containers of the single use disposable type for liquid foods are often produced from a packaging material based on paperboard or carton. One such commonly occurring packaging container is marketed under the trademark Tetra Fino® Aseptic and is principally employed for aseptic packaging of liquid foods such as milk, fruit juices etc, marketed and sold for long term ambient storage. The packaging material in this known packaging container is typically a laminate comprising a bulk layer of paper or paperboard and outer, liquid-tight layers of thermoplastics. In order to render the packaging container gas-tight, in particular oxygen gas-tight, for example for the purpose of aseptic packaging such as packaging of milk or fruit juice, the laminate in these packaging containers normally comprises at least one additional such gas barrier layer, most commonly an aluminium foil.

On the inside of the laminate, i.e. the side intended to face the filled food contents of a container produced from the laminate, there is an innermost layer, applied onto the aluminium foil, which innermost, inside layer may be composed of one or several part layers, comprising heat-sealable adhesive polymers and/or heat-sealable polyolefins. Also on the outside of the paper or paperboard bulk layer, there is an outermost heat-sealable polymer layer (decor layer). The heat-sealable polymer layers are often based on low density polyethylene or blends thereof.

The packaging containers are generally produced by means of modern, high-speed packaging machines of the type that continuously form, fill and seal packages from a web or from prefabricated blanks of packaging material, e.g. Tetra Fino® Aseptic-type packaging machines. Packaging containers may thus be produced by the so-called form-fill-seal technology basically including continuous reforming a web of the laminated packaging material by means of a filling machine which forms, fills and seals the web into packages. More specifically, a continuous tube is formed from the web-fed packaging material; the web of packaging material is sterilized by applying a chemical sterilizing agent, such as a hydrogen peroxide solution, which, once sterilization is completed, is removed from the surfaces of the packaging material, e.g. evaporated by heating; and the web of packaging material so sterilized is maintained in a closed, sterile environment, and is formed into a vertical tube by sealing the longitudinal edges of the tube in an overlapping seal. The tube is filled with the food product, and is sealed and subsequently cut along equally spaced transverse sealing zones to form cushion-shaped or pillow-shaped packing containers.

An aspect of the Tetra Fino®-type packaging method is, as stated above, the possibility of continuous high-speed packaging, which has considerable impact on cost efficiency. Typically many thousands of packages may be prepared per hour. For example the Tetra Pak® A1 may manufacture about 10 000 packaging containers per hour (packaging containers of 0.5 litres or more), and about 15 000 packaging containers per hour (portion packages)

The Tetra Fino® Aseptic packaging containers are, as mentioned above, cushion-shaped or pillow shaped and commonly such packaging containers have an opening device that is generally provided in the form of a straw hole, or simply as a cut indicator, which is facilitated by a rather thin and thus tearable packaging material being used. However, these opening devices cannot be closed again after initial opening. Conventional closure devices, i.e. re-closable opening devices, comprises for example screw caps and flip caps. Using for example screw caps or flip caps would in most cases be fully functional. However, the type of packaging container is a high-volume (in terms of packaging containers per time unit) and low-cost packaging container (due to the properties of the packaging material), and such closure devices might hamper the production speed and be detrimental for the cost of the packaging container.

For this reason there is a need for a closure device having a high efficiency in regard of the amount of material used and the time needed for production of each closure device. It should be emphasized that even if the present invention was developed to solve a specific problem, the outcome may be applied to packages in a general sense and it should not be limited to a particular type of packages in this respect.

### OBJECTS OF THE INVENTION

At least the above need has been solved by the present invention.

A first aspect of the invention relates to a closure device for re-closing an opening on a packaging container for liquid or semi-liquid food. Said opening has been initially opened within an opening area. Said packaging container is provided with a first fold axis. The closure device comprises at least a first closure device part and at least a second closure device part. The first closure device part is arranged on a first side of the first fold axis and the second closure device part is arranged on a second side of the first fold axis. The first closure device part is arranged between the opening area and the first fold axis. The first and second closure device parts are provided with mutual lockable members such that the first and second closure device parts may be releasably locked to each other upon folding the packaging container along the first fold axis thereby re-closing the opening in the packaging container.

In one or more embodiments the first and second closure device parts are separated at least a distance cross the first fold axis, to allow the closure device to be folded at the first fold axis.

In one or more embodiments the first closure device part is at least partly aligned along the first fold axis, and the second closure device part is at least partly aligned along the first fold axis.

In one or more embodiments the first and second closure device parts are arranged on a first face of the packaging container.

In one or more embodiments the packaging container has a transverse seal zone and second and third fold axes. The opening area and said first fold axis intersect the transverse seal zone and the second fold axis or the third fold axis.

In one or more embodiments the first fold axis is angled an angle with respect to the second or the third fold axes.

In one or more embodiments the first closure device part extends along the first fold axis a substantial portion of the distance from one of the second or third fold axes to the transverse seal zone.

In one or more embodiments the first closure part extend along more than 40% of the distance from one of the second or third fold axes to the transverse seal zone, particularly more than 80%.

In one or more embodiments the second opening part extends along the first fold axis a substantial portion of the distance from one of the second or third fold axes to the transverse seal zone.

In one or more embodiments the second closure part extends along more than 40% of the distance from one of the second or third fold axes to the transverse seal zone, particularly more than 80%.

In one or more embodiments the packaging container has a transverse seal zone and second and third fold axes, wherein the first fold axis intersects the second fold axis and the third fold axis.

In one or more embodiments the first fold axis is substantially parallel to the transverse seal zone.

In one or more embodiments one or both of the first and second closure device parts extend along the first fold axis from the second fold axis to the third fold axis.

In one or more embodiments the opening area is positioned between the transverse seal zone and the first closure device part.

In one or more embodiments the first closure device part has a hinge area which divides the first closure device part into two portions, wherein said hinge area has a hinge axis that intersects the first fold line.

In one or more embodiments the closure device further comprises an opening device adapted for opening the packaging container along an opening line, said opening device having a second fold line, said fold line and opening line intersect in an intersection point, said intersection point dividing the opening line into a first opening line portion and a second opening line portion. The opening device further comprises a first opening device portion and a second opening device portion. The first opening device portion has an opening edge that is at least partly aligned along the first opening line portion and arranged on a first side of the opening line. The second opening device portion is the first closure device part and has an opening edge that is at least partly aligned along the second opening line portion and arranged on a second side of the opening line. A consumer can fold the opening device at the second fold line and force the opening edges of the first and second portions to act against each other to facilitate rupture of the packaging material along the opening line.

In one or more embodiments the closure device is arranged such, on the packaging container, that the second fold line corresponds to the second fold axis of the packaging container.

In one or more embodiments the first opening line portion is arranged to substantially coincide with the second opening line portion when the opening device is folded along the first fold line.

In one or more embodiments each of the first and second opening line portions is angled an angle with respect to the second fold line.

In one or more embodiments the angle of the first and second opening line portions is similar to the angle of the first fold axis.

In one or more embodiments the second opening line portion is a mirror of the first opening line portion around the second fold line.

In one or more embodiments the first opening device portion has a fold edge that is at least partly aligned along the second fold line and arranged on a first side of said fold line, and the second opening device portion has a fold edge that is at least partly aligned along the second fold line and arranged on a second side of said fold line.

In one or more embodiments the fold edges are each arranged at a first distance from the second fold line, to allow the opening device to be folded at the second fold line.

In one or more embodiments the opening edges are each arranged at a second distance from the opening line to form an opening slot between them when the opening device is folded at the second fold line.

In one or more embodiments the opening device comprises a third opening device portion and a fourth opening device portion, the third opening device portion is provided on the second side of the second fold line and is a mirror of the first opening device portion around the second fold line, and the fourth opening device portion is provided on the first side of the second fold line and is a mirror of the second opening device portion around the second fold line.

In one or more embodiments the first and third opening device portions are connected to each other by a first bridge, the second and fourth opening device portions are connected to each other by a second bridge, and said bridges are arranged to form hinge areas when the opening device is folded along the second fold line.

In one or more embodiments the first opening device portion comprises a tab section.

In one or more embodiments the third opening device portion comprises a tab section.

In one or more embodiments the closure device is made of a polymeric material and the closure device is injection molded onto the packaging container before forming of the packaging container.

In one or more embodiments the opening device is provided with a pouring lip. The pouring lip is arranged on the second side of the opening line and is substantially centered in relation to the intersection point of the second fold line and the opening line.

A second aspect of the invention relates to a method of manufacturing a packaging container with a closure device. The method comprises the steps of:

providing a packaging material comprising a bulk layer, which on a first side has a polymer layer,

moulding the closure device onto the first side of the packaging material, said closure device comprises a first closure device part and a second closure device part, wherein the first closure device part is moulded on a first side of a first fold axis and the second closure device part is moulded on a second side of the first fold axis, said fold axis is an axis around which the packaging container is adapted to be folded in order to re-close the packaging container,

forming the packaging material into a tube by sealing overlapping longitudinal edges thereof,

filling the tube with a liquid or semi-liquid food product,

sealing the tube along transverse seal zones to form a cushion-shaped packaging container, said sealing being made such that the packaging material is folded around second and third fold axes in the seal zones, and such that the closure device is positioned in one end of the packaging container, near a transverse seal zone.

In one or more embodiments the step of moulding comprises the steps of: arranging, on the first side of the packaging material, a first mould portion comprising at least a first mould cavity, arranging a second mould portion on the other side of the packaging material, positioned opposite the first mould portion, injecting a plastic melt into the first mould cavity, and removing the first and the second mould portions.

In one or more embodiment the packaging material is a web for forming more than one packaging container, and the step of sealing comprises sealing the tube along transverse mutually apart seal zones to form cushion-shaped packaging containers, and the method further comprises the step of separating the packaging containers from the tube by incisions in the seal zones.

A third aspect of the invention relates to a packaging container for liquid or semi-liquid food. The packaging container is made of a longitudinal tube of packaging material which has been sealed off in the ends by first and second transverse seal zones to form a cushion-shape, and which packaging material has been folded around second and third fold axes in the transverse seal zones. The packaging container is provided with an opening area in which the packaging container is adapted to be opened. It is further provided with a first fold axis and a closure device for re-closing an opening after the packaging container has been initially opened within the opening area. Said closure device comprises a first closure device part and a second closure device part. The first closure device part is arranged on a first side of the first fold axis, the second closure device part is arranged on a second side of the first fold axis, the first closure device part is arranged between the opening area and the first fold axis, and the first and second closure device parts are provided with mutual lockable members such that the first and second closure device parts may be releasably locked to each other upon folding the packaging container along the first fold axis thereby re-closing the opening in the packaging container.

### BRIEF DESCRIPTION OF THE DRAWINGS

Further advantages and favorable characterizing features will be apparent from the following detailed description. Equal or corresponding elements are denominated by the same reference numerous in all figures. The features described in connection with the different embodiments can be combined as far as technically possible. The embodiments will be described with reference to the appended figures, in which:

FIG. 1 is a schematic view of a first embodiment of a closure device of the invention shown on a portion of a packaging container,

FIG. 2 is a schematic view of a second embodiment of the closure device according to the invention.

FIG. 3 is a schematic view of a third embodiment of the closure device according to the invention.

FIG. 4 is a schematic view of a fourth embodiment of the closure device according to the invention.

FIG. 5 is a schematic view of a packaging container provided with the closure device of FIG. 1.

FIG. 6 is a schematic view of the packaging container of FIG. 5 after initial opening of the closure device has been made.

FIG. 7 is a schematic view of the packaging container of FIGS. 5 and 6 after re-closure of the closure device has been made.

FIG. 8 is a schematic view of the packaging container of FIG. 4 after re-closure of the closure device has been made.

FIG. 9 is a schematic view of a cross section along the line A-A in FIG. 5.

FIG. 10 is a schematic view similar to that of FIG. 9 after the activation of hinge areas.

FIG. 11 is a schematic, planar view of a fifth embodiment of the invention.

FIG. 12a is a schematic, planar view of a sixth embodiment of the invention.

FIG. 12b is a schematic view of the closure device of the sixth embodiment and a portion of a packaging container.

FIG. 12c is a schematic view of the opening device of the closure device being opened.

FIG. 12d is a schematic view of the closure device of the sixth embodiment in a re-closed state.

### DETAILED DESCRIPTION OF EMBODIMENTS

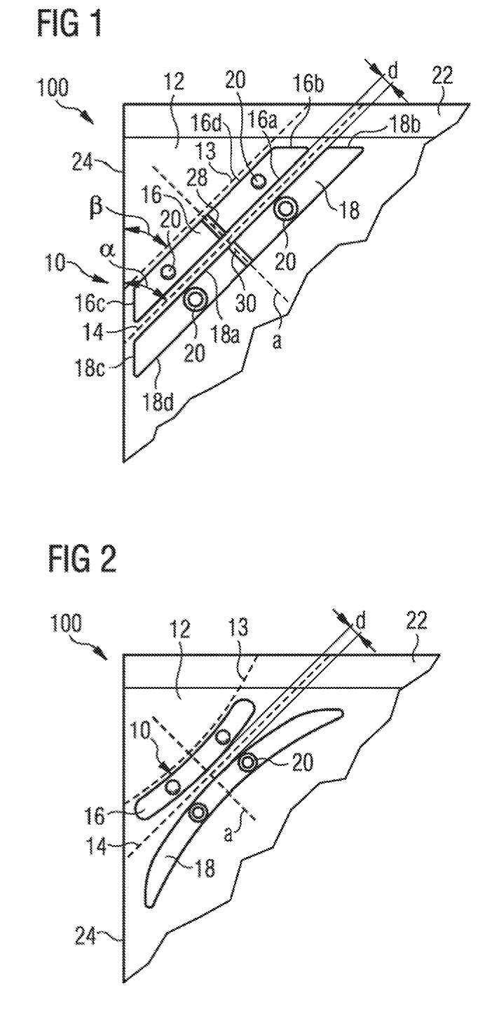

FIG. 1 shows a first embodiment of a closure device of the invention. The closure device is denoted 10 and is positioned on a packaging container 100 (of which only a portion is shown in the figure). The closure device 10 comprises a first closure device part 16 and a second closure device part 18. The closure device parts 16, 18 will be described with reference to a first fold axis 14 and an opening area 12 of a packaging container. The opening area 12 is in one end delimited by a line 13. Within the opening area 12 the packaging container 100 may be opened along any imaginary line or curve. The consumer may open the packaging container by cutting it open by scissors or by tearing it open somewhere in the opening area 12. In the latter case the opening area 12 may be provided with a perforated line or curve to assist the consumer.

The first fold axis 14 is an axis around which the consumer will fold the packaging container 10 in order to re-close it after the initial opening.

The first closure device part 16 is arranged on a first side of the first fold axis 14. The second closure device part 18 is arranged on a second side of the first fold axis 14. As can be seen in the figure the first closure device part 16 is arranged between the opening area 12 and the first fold axis 14.

The first closure device part 16 is at least partly aligned along the first fold axis 14. In this first embodiment the part 16 is elongate and extends parallel with the first fold axis 14. Similarly, the second closure device part 18 is at least partly aligned along the first fold axis 14. It is also elongate and extends parallel with the first fold axis 14. Hence, in this embodiment the first and second closure device parts 16, 18 extend parallel to each other.

The first and second closure device parts 16, 18 are separated a distance d cross the first fold axis 14, to allow the closure device 10 to be folded along the first fold axis 14. This will be described further in relation to FIG. 7. The distance d is in the range of 0-10 mm, particularly 1-5 mm.

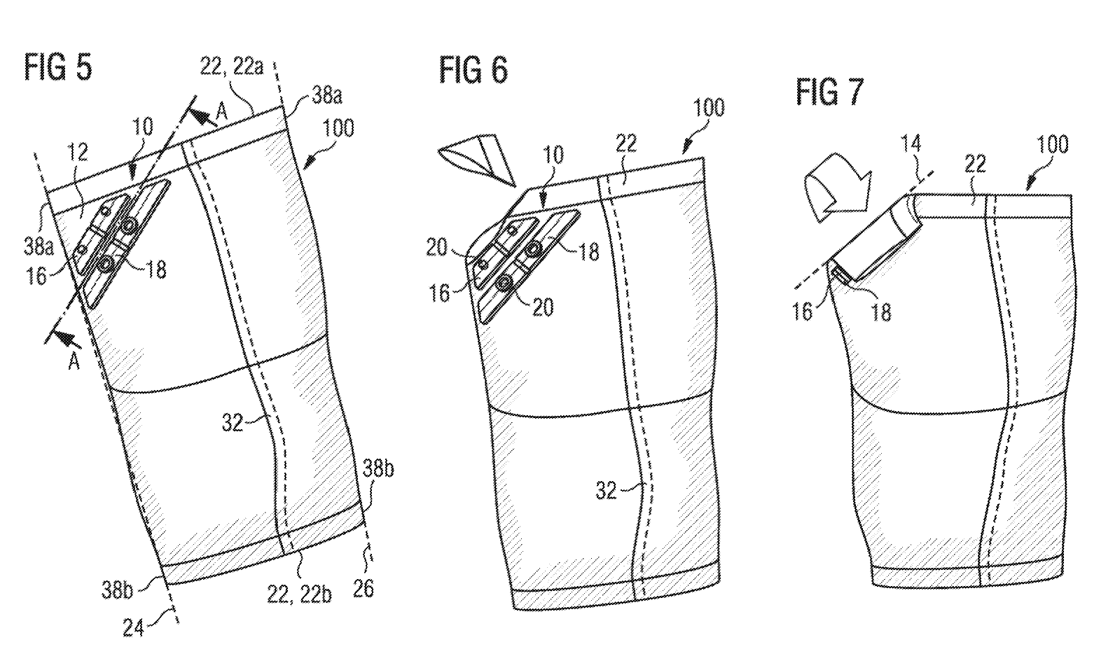

The packaging container 100 has a transverse seal zone 22 and second and third fold axes 24, 26 (of which only the second fold axis being visible in FIG. 1). These will be further described later in relation to FIG. 5. As can be seen in FIG. 1 the opening area 12 and the first fold axis 14 intersect the transverse seal zone 22 and the second fold axis 24. Further, the first fold axis 14 is angled an angle α with respect to the second fold axis 24. The line 13 delimiting the opening area 12 is similarly angled an angle β with respect to the second fold axis 24. The angle α and the angle β may be similar, as they are in the shown embodiment, but they may as well be different to each other. A suitable range of angles for the angles α and β are 20-80°, particularly 30-50°. The opening area 12 is, as shown in FIG. 1, triangular. As mentioned before it is in one end delimited by the line 13. The edge of the packaging container 100 at the transverse seal zone 22 and the second fold axis are the other delimiting lines of the opening area 12.

As can be further seen from FIG. 1 the first closure part 16 extends substantially all the way along the first fold axis 14, from the second fold axis 24 up to the transverse seal zone 22, and has a first edge 16a parallel to the first fold axis 14. The first closure device part 16 also has a second edge 16b at least partly parallel to the transverse seal zone 22, and a third edge 16c at least partly parallel to the second fold axis 24. The first closure device part 16 also has a fourth edge 16d at least partly parallel to the line 13 delimiting the opening area 12. The fourth edge 16d is also parallel to the first edge 16a. Similarly, the second closure device part 18 extends substantially all the way along the first fold axis 14, from the second fold axis 24 to the transverse seal zone 22. In this embodiment the second closure device part 18 has a first edge 18a parallel to the first fold axis 14. The second closure device part 18 further has a second edge 18b at least partly parallel to the transverse seal zone 22, and a third edge 18c at least partly parallel to the second fold axis 24. The second closure device part 18 also has a fourth edge 18d. The fourth edge 18d is parallel to the first edge 18a.

The first and second closure device parts 16, 18 are provided with mutual lockable members 20 such that the first and second closure device parts 16, 18 may be releasably locked to each other. The lockable members 20 can be any of a large variety of types, for example the locking function can be mechanical such as for example as a snap lock, or snap fit, solution, either in points or along a line, the latter being similar to a conventional zip lock. Further, it can be chemical or a combination of mechanical and chemical such for example a locking function based on surface friction or surface adherence between the outwards facing surfaces of the first closure device part 16 and the second closure device part 18. In this first embodiment the lockable members are shaped for mechanical locking by snap action. The lockable members 20 of the first closure device part 16 are two male locking portions and the lockable members 20 on the second closure device part 18 are two corresponding female locking portions. Hence the first closure device part 16 can be releasably locked to the second closure device part 18.

Further, the first closure device part 16 has a hinge area 28 which divides the first closure device part 16 into two portions, an upper portion and a lower portion. The hinge area 28 has a hinge axis a that intersects the first fold line 14. In this embodiment the hinge axis a is perpendicular to the fold axis 14, and thus also to the line 13 delimiting the opening area 12. A similar hinge area 30 is provided on the second closure device part 18, having the same hinge axis a. Hence, the hinge areas 28, 30 are aligned with each other. The function of the hinge areas 28, 30 will be described with regard to FIG. 10.

The two male locking portions provided on the first closure device part 16 are placed one on each side of the hinge area 28, i.e. one is arranged on the upper portion and one is arranged on the lower portion. Similarly, the two corresponding female locking portions are provided one on each side of the hinge area 30 of the second closure device part 18.

FIG. 2 shows a second embodiment of a closure device according to the invention. Only the difference compared to the first embodiment will be described, and the difference lies in the shape of the first and second closure device parts 16, 18. In this embodiment the first and second closure device parts 16, 18 are curved. The first closure device part 16 is concave in relation to the first fold line 14, and the second closure device part 18 is also concave in relation to the first fold line 14. A mid portion of the second closure device part 18 is at least partly a mirror of the first closure device part 16 around the fold line 14. The distance d is in this case the shortest distance between the first and second closure device parts 16, 18.

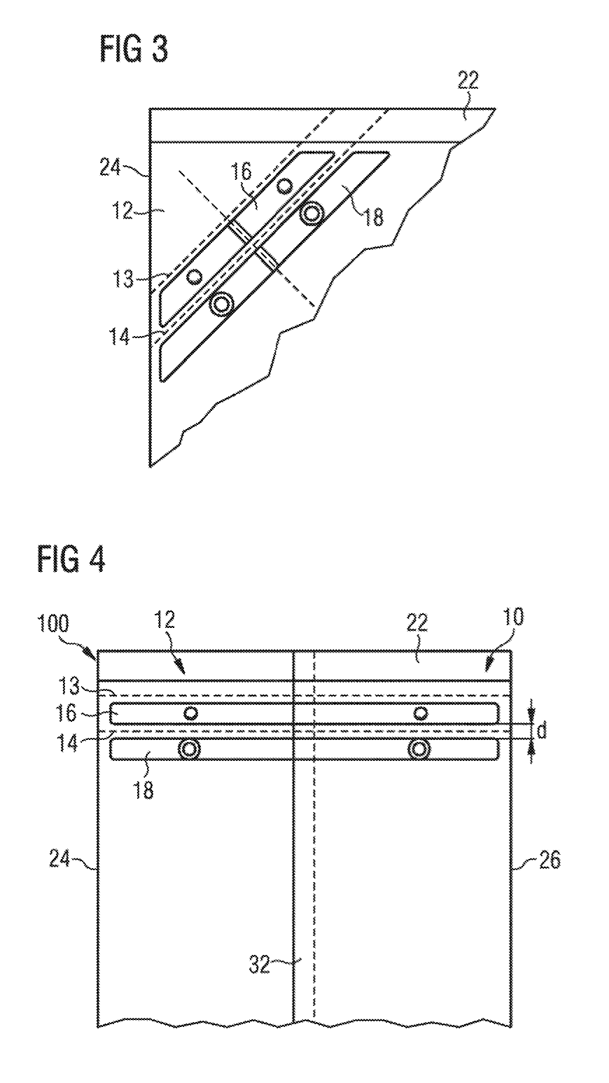

FIG. 3 shows a third embodiment of a closure device according to the invention. It is very similar to the first embodiment and only the difference will be described. The hinge areas 28, 30 of the first embodiment are here left out and replaced by an empty space between the upper and lower portions of the first and second closure device parts 16, 18, i.e. the upper and lower portions are separated from each other.

FIG. 4 shows a fourth embodiment of the closure device 10. Only the differences from the first embodiment will be described. In the fourth embodiment the first fold axis 14 is substantially parallel to the transverse seal zone 22 before the packaging container 100 has been opened. The first and second closure device parts 16, 18 are longer and extend substantially all the way from the second fold axis 24 to the third fold axis 26. The opening area 12, at which the packaging container is supposed to be initially opened, and its delimiting line 13, extend parallel to the transverse seal zone 22. The delimiting line 13 extends in between the transverse seal zone 22 and the first closure device part 16. The opening area 12 encompasses the transverse seal zone 22 and the area down to the delimiting line 13.

FIG. 5 shows a packaging container 100 provided with a closure device 10. The closure device shown is of a type according to the first embodiment. As can be seen the first and second closure device parts 16, 18 are arranged on a first face of the packaging container.

The packaging container 100 is made of a longitudinal tube, having a longitudinal seal 32, of packaging material which has been sealed off in the ends by first and second transverse seal zones 22 to form a cushion-shape. In the seal zones inner heat sealable layers of the packaging material have been sealed together to form a tight seal. As the packaging containers are of the pouch type it does not have any defined longitudinal edges. However, at outermost edges 38 of the transverse seal zones 22 the packaging material is folded, since the transverse seal is made transverse to a tube. The second fold axis 24 previously referred to is an imaginary axis extending longitudinally from an upper outermost edge 38a of a first transverse seal zone 22a to a corresponding, lower outermost edge 38b of a second transverse seal zone 22b. The second fold axis 24 extends the shortest possible distance between the edges 38a, 38b. The third fold axis 26 extends in a similar way.

The packaging container 100 is filled with a liquid or semi-liquid food product. The term “liquid or semi-liquid food” generally refers to food products having a flowing content that optionally may contain pieces of food. Dairy and milk, soy, rice, grains and seed drinks, juice, nectar, still drinks, energy drinks, sport drinks, coffee or tea drinks, coconut water, tea drinks, wine, soups, jalapenos, tomatoes, sauce (such as pasta sauce), beans and olive oil are some example of food products contemplated.

FIG. 9 shows the first embodiment, but in a view corresponding to section A-A taken from FIG. 5. As can be seen the closure device 10 is only provided on an outer side of the packaging material.

Preferably, the closure device 10 is injection-moulded or glued onto the packaging material, preferably to what will become the outside surface of a packaging container. The material thickness t of the opening device, in a direction perpendicular to the packaging material surface, is in the range of 0.2-2 mm. The corresponding packaging material thickness is in the range of 0.2-1.5 mm.

FIG. 6 shows the packaging container of FIG. 5 but after initial opening made by a consumer. A consumer has cut or torn off the corner of the packaging container and has formed an opening within the opening area 12. Possibly, the opening line, along which the consumer is supposed to open the packaging container, is visible, for instance as a line in a decor layer. It may even be provided as a weakening line comprised by a perforated line in a bulk layer of the packaging material. The opening line may correspond to the line 13 delimiting the opening area 12 (line 13 is shown in for example FIG. 1).

Upon opening the hinge areas 28, 30 will help forming the opening. This is shown in FIG. 10 being a similar section as FIG. 9. The consumer can squeeze together the ends of the closure device to “activate” the hinges 28, 30 (30 not shown in FIGS. 9 and 10, but in for example FIG. 1), i.e. fold the first and second closure device parts around the hinge axis a. In this way the two inner faces of the packaging container will separate easily from each other and form a pour opening. The polymeric material will to some extent undergo plastic deformation and will keep the opening open, i.e. will keep the inner faces of the packaging material separated from each other in the opening.

FIG. 7 shows the packaging container 100 of FIG. 6 in a re-closed state using the closure device 10 of the invention. The packaging container is re-closed by folding, around the first fold axis 14 as indicated by the arrow, such that the first closure device part 16 contacts the second closure part 18. The lockable members 20 of the first closure part 16 may then be releasably locked to the lockable members 20 of the second closure part 18. The packaging container may be opened again by releasing or losing the lockable members 20, and unfold the packaging container 100.

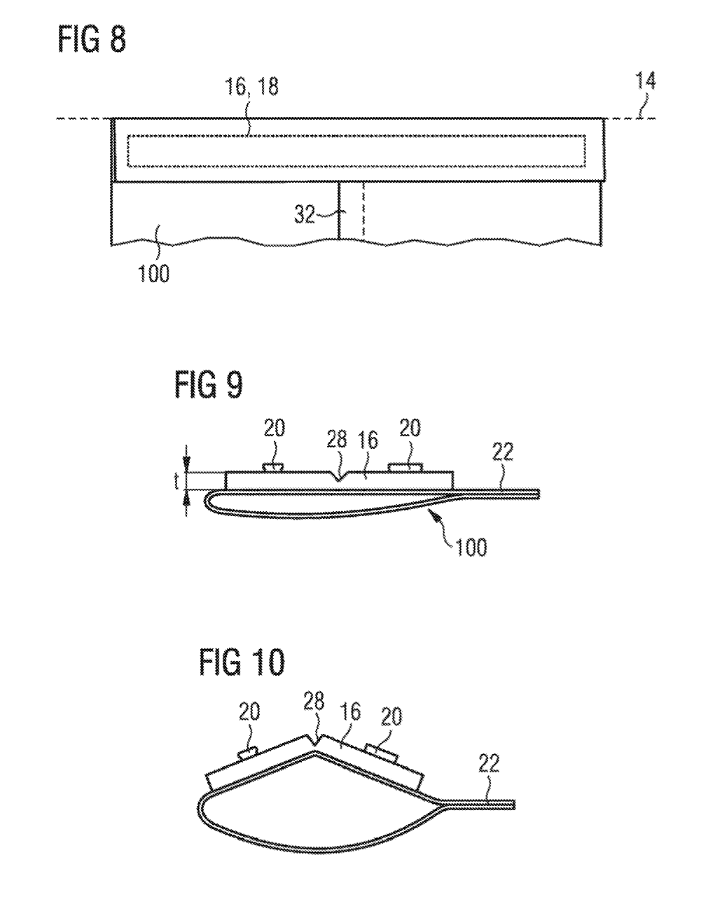

FIG. 8 shows the packaging container of FIG. 4 in a re-closed state corresponding to the re-closed state shown in FIG. 7 of the first embodiment. The entire upper edge of the packaging container has been folded, around the first fold axis 14, and the first and second closure parts 16, 18 have been locked to each other by means of the lockable members 20. The first and second closure parts 16, 18 are shown with hidden lines in FIG. 8.

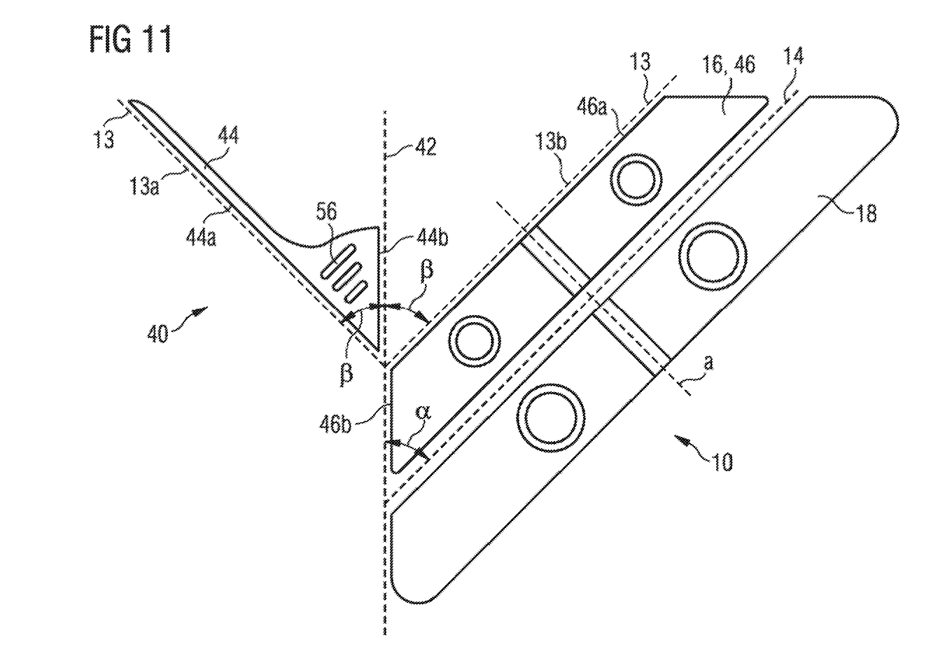

FIG. 11 shows a fifth embodiment of the closure device of the invention. It is similar to the first embodiment, but is provided with an opening device by means of which the consumer more easily can open the packaging container.

The opening device is denoted 40 and comprises a first opening device portion 44 and a second opening device portion 46. The second opening device portion 46 is the previously described first closure part 16.

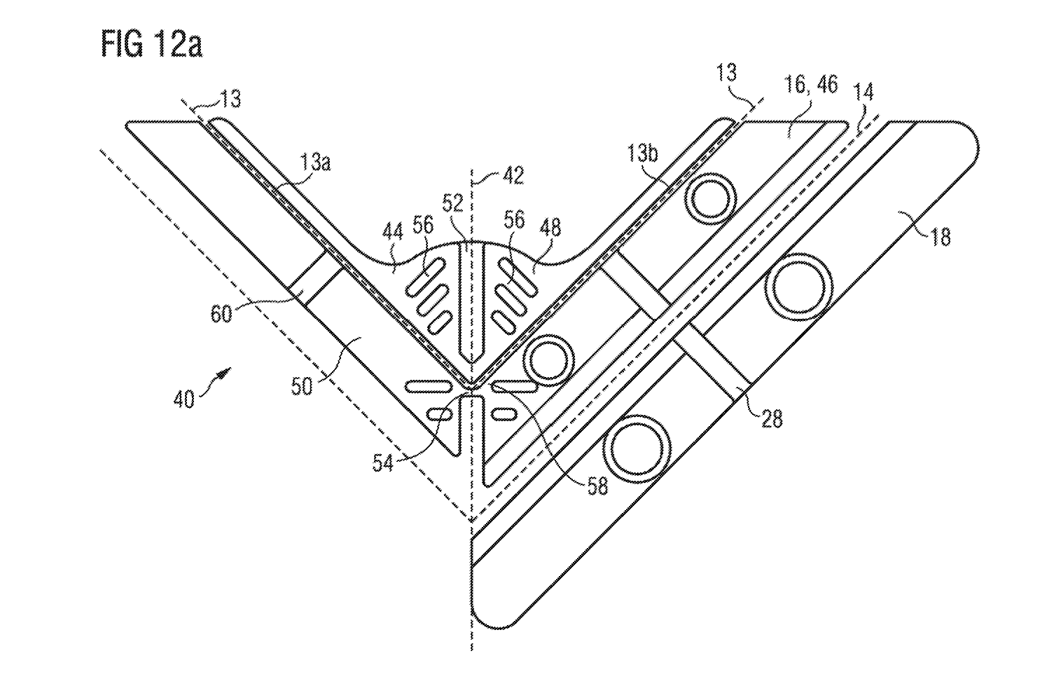

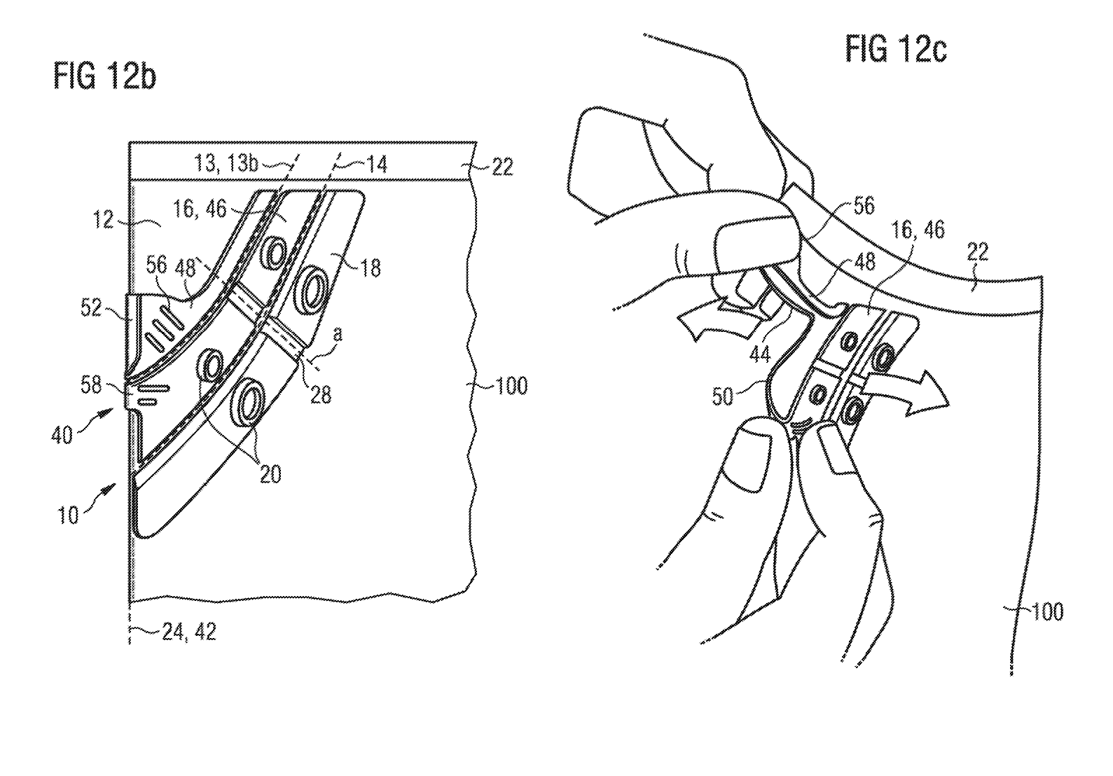

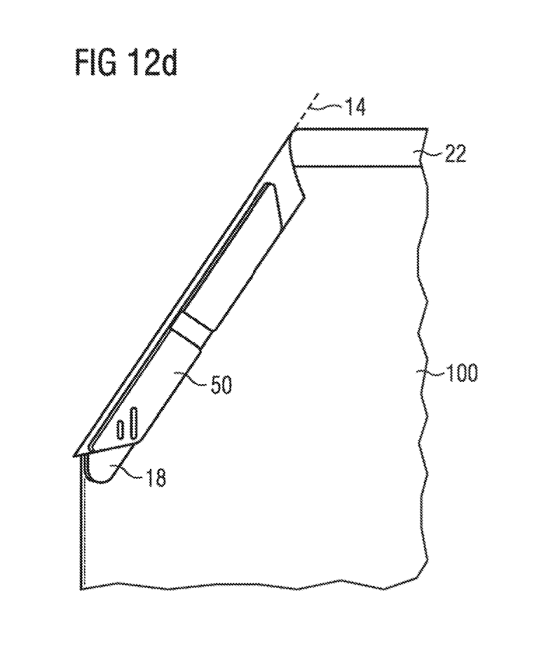

The opening device portions 44, 46 will be described with reference to a second fold line 42 and an opening line 13 of a packaging container. The second fold line 42 coincides with the second fold axis 24 of the packaging container (as seen in FIG. 12b). The second fold line 42 and the opening line 13 intersect in an intersection point, and said intersection point divides the opening line 13 into a first opening line portion 13a and a second opening line portion 13b.

The first opening device portion 44 is arranged on a first, left side of the second fold line 42. Further it is arranged on a first, upper side of the opening line 13. The second opening device portion 46, i.e. the first closure device part 16, is arranged on a second, right side of the second fold line 42. Further it is arranged on a second, lower side of the opening line 13.

The first opening device portion 44 is elongate and has an opening edge 44a that extends along the first opening line portion 13a. The opening edge 44a is straight and substantially parallel to the first opening line portion 13a, i.e. the opening edge 44a is aligned along the first opening line portion 13a.

Correspondingly, the second opening device portion 46 is also elongate and has an opening edge 46a that extends along the second opening line portion 13b. The opening edge 46a is also straight, and is parallel to the second opening line portion 13b, i.e. it is aligned along the second opening line portion 13b. The second opening line portion 13b is parallel to the first fold line 14.

The opening line 13 is an imaginary line along which the opening device will be opened, i.e. along which the packaging material of the packaging container will be ruptured or torn. The second fold line 42 is a longitudinal imaginary line along which the opening device can be folded during opening.

In this embodiment the first opening line portion 13a is angled an angle β in relation to the second fold line 42. Similarly, the second opening line portion 13b is angled an angle β in relation to the second fold line 42. The angle may be in the range 20-90°, particularly 45-90°. Together the first and second opening line portions 13a, 13b together form an obtuse V-shape. The angle β is preferably equal to the earlier described angle α, i.e. the angle α being the angle of the first fold line 14 in relation to the second fold line 42.

In this embodiment the first opening device portion 44 is further comprising a fold edge 44b. The fold edge 44b is aligned along the second fold line 42, i.e. it is parallel to the second fold line 42. Correspondingly, the second opening device portion 46 comprises a fold edge 46b. That fold edge 46b is also aligned with the second fold line 42, i.e. is parallel to the second fold line 42.

The fold edges 44b, 46b of the first and second opening device portions 44, 46 are each arranged at a first distance from the second fold line 42. The distance is in the range of 1-2 mm.

The distance facilitates folding of the opening device 40 around the second fold line 42.

Furthermore, the opening edges 44a, 46a of the first and second opening device portions 44, 46 are each arranged at a second, small distance from the opening line 13. The distance is in the range of 0.2-1.0 mm.

The distance facilitates rupture of the packaging material along the opening line.

The first opening device portion 44 is provided with a tab section 56 providing an area where a consumer can grab the opening device with his or her fingers. The tab section 56 may be provided with a tactile pattern in order to facilitate gripping, for example a relief or recess pattern. Preferably, the pattern is a recess pattern rather than a relief pattern, meaning that the tab portions 56 have recesses in which the material thickness is less than the material thickness of the rest of the tab portion 56, in order to use as little polymer material as possible. The tab section 56 in this embodiment has a convex shape.

FIG. 12a shows a sixth embodiment of the invention. This closure device 10 also has an opening device 40. To a large extent this opening device 40 is similar to the opening device as shown in FIG. 11. The opening device 40 has first and second opening device portions 44, 46 similar to the first and second opening device portions of the fifth embodiment. The difference is that this sixth embodiment comprises further opening device portions, namely a third opening device portion 48 and a fourth opening device portion 50. The third opening device portion 48 is provided on the second side of the second fold line 42, and is a mirror of the first opening device portion 44 around the second fold line 42. The fourth opening device portion 50 is provided on the first side of the second fold line 42, and is partly a mirror of the second opening device portion 46 around the second fold line 42.

The first and third opening device portions 44, 48 are connected to each other by a first bridge 52. Further, the second and fourth opening device portions 46, 50 are connected to each other by a second bridge 54. The bridges function as hinge areas and allow the opening device 40 to be folded at the second fold line 42. The fourth opening device portion 50 has a hinge area 60 corresponding to the hinge area 28 of the first and second closure device parts 16, 18.

The second bridge 54 is provided with a pouring lip 58, i.e. an element protruding from the opening device and the packaging container along a central portion of the opening line 13. The pouring lip 58 extends from the second fold line 42 and along each of the first and second opening line portions 13a, 13b. The pouring lip 58 extends a distance, on each side of the second fold line 42, substantially corresponding to a substantial portion of the width of the tab sections 56. In FIG. 12b the opening device 40 is shown from the side on a packaging material, and it can be seen that the pouring lip 58 is protruding from the rest of the opening device 40.

In FIG. 12b the closure device 10 of the sixth embodiment is shown in a folded state on a packaging container 100. The packaging container is only partly shown. Folding has been made at the second fold line 42, i.e. along or around the second fold line 42. The closure device 10 is provided in an upper corner of the packaging container 100, as best seen in FIG. 5, and close to an upper transverse seal zone 22. The first opening device portion 44 is positioned on a back face of the packaging container, and hence not shown, whereas the second opening device portion 46, the third opening device portion 48 and the second closure device part 18 are positioned on a front face of the packaging container 100.

When folded the first opening line portion 13a coincides with the second opening line portion 13b (not shown).

The corner area 12 of the packaging container 100 can be opened and removed using the opening device 40. It will in the following, and with reference to FIG. 12c, be described how the opening device 40 of closure device 10 can be used for opening the packaging container 100. The opening technique is basically similar for the various embodiments.

Upon opening a consumer will typically grip around the tab sections 56 with the index finger and the thumb of one hand and similarly grip around the second opening device portion 46 and the fourth opening device portion 50 with the other hand. By doing so the consumer can fold the opening device 40 at the second fold line 42. By further forcing the tab sections 56 away from the second and fourth opening device portions 46, 50, in the directions shown by the arrows, the opening edges of the first and third opening device portions will act against the opening edges of the second and fourth opening device portions in order to initially break the packaging material in the intersection point, and then facilitate rupturing the packaging material along the opening line 13. The edges will act as scissors blades.

To further facilitating the rupture along the opening line 13 it may be considered to provide the opening line as a weakening line, such as for example a line at which one or more of the packaging material layers have been perforated or in other way been weakened.

The pouring lip 58 helps separating the front side of the packaging container from the back side and forming the opening. Even if the second and fourth opening device portions 46, 50 have been squeezed together during opening, the stiffness of the polymer material in the pouring lip 58 will to some extent spring back and thereby facilitate the formation of an opening with good pouring characteristics. The pouring lip 58 will help the opening form a rounded shape at the intersection between the opening line 13 and the second fold line 42.

FIG. 12d shows the re-closed state, similar to that of FIG. 7. The packaging container 100 is re-closed by folding, around the first fold axis 14 as indicated by the arrow, such that the first closure device part 16 contacts the second closure part 18. The lockable members 20 of the first closure part 16 (not visible) may then be releasably locked to the lockable members 20 of the second closure part 18. The packaging container may be opened again by releasing or losing the lockable members 20, and unfold the packaging container 100. The fourth opening device portion 50 will act as reinforcement and facilitate the re-closure.

In the following manufacturing of the packaging container 100 with the closure device 10 will be described.

A first step of the method is to provide a packaging material. The packaging material generally comprises a bulk layer, which on a first side has a polymeric layer. The bulk layer can be a paper or paperboard layer. The bulk layer is arranged to provide for the greatest contribution to the flexural rigidity of the laminate. The paper or paperboard used herein has a typical grammage between 50-250 g/m², particularly between 60-220 g/m², depending on the requirement for different types of packaging containers. The grammage of the paperboard is assessed in accordance with ISO 536. Grammage expresses weight per unit area and is measured in g/m². The paper or paperboard normally has a thickness between 80-300 μm, particularly between 90-290 μm, and is appropriately selected in order to obtain the desired stiffness suitable for the type of packaging container and the intended food product. The bulk layer thickness can be assessed by microscopy. It is however also conceivable that the bulk layer of the packaging material instead is a polyolefin bulk layer, made e.g. of polyethylene, polypropylene or copolymers of ethylene or propylene, such as, for example, ethylene-propylene, ethylene-butene, ethylene-hexene, ethylene-alkyl(meth)acrylate or ethylene-vinyl acetate copolymers, or PET (polyethylene terephthalate) bulk layer.

The polymeric layer is a décor layer which is to be the outer side of the filled and sealed packaging container. The side of the bulk layer, e.g. paper or paperboard, which is to be the outer side of the closed and sealed packaging container can contain a print covered by the decor layer. The decor layer is a heat-sealable polyolefin layer facing the surrounding environment of the resulting packaging container. Suitable polyolefins are polyethylene of the low density type, selected from the group consisting of LDPE, LLDPE, VLDPE, ULDPE or mLLDPE and blends of two or more thereof, optionally other polyolefins such as high density polyethylene (HDPE), polypropylene or propylene co- or ter-polymers are useful as the layer facing the surroundings. The decor layer provides additional protection and stability to the packaging container.

In addition, the packaging material comprises an innermost heat-sealable layer of a heat-sealable polyolefin polymer which is applied as a layer to be directed towards the inside of the packaging container, i.e. in direct food contact. The heat-sealable layer for the innermost layer may suitably be a polyethylene polymer of the low density type, selected from the group consisting of LDPE, LLDPE, VLDPE, ULDPE or mLLDPE and blends of two or more thereof. Depending on the type of packaging containers produced from the packaging material, also heat-sealable innermost layers of high density polyethylene, polypropylene or propylene co- or ter-polymers are conceivable.

Furthermore, the packaging material may comprise a barrier layer, such as an oxygen barrier, for instance aluminium foil, as well as suitable adhesion layers to increase adherence between the layers. The barrier layer is arranged by help of a laminate layer on the side opposite the bulk layer and has an adhesive on the side opposite the laminate layer. The adhesive depends on the type of bulk layer and the barrier layer and are within the capacity of those skilled in the art to select.

One exemplary packaging material comprises a decor layer which on one side of the layer has a paperboard layer, said paperboard layer, on the side opposite the decor layer has a laminate layer, said laminate layer, on the side opposite the paperboard layer has an oxygen barrier, said oxygen barrier, on the side opposite the laminate layer has an adhesive, and said adhesive, on the side opposite the oxygen barrier has a heat-sealable layer.

Laminated packaging materials are obtained by various methods for laminating layers together, such as extrusion lamination, dry adhesive lamination, heat-pressure lamination, and may also be including various coating methods. Although to achieve the benefits the particular lamination technique is not crucial it is considered to be of particular use in extrusion lamination to produce laminated packaging materials, in particular carton-based packages used for food such as liquid and semi-liquid food.

The term “heat-sealing” used above refers to the process of sealing of a thermoplastic material with another. Thus a heat-sealable material should be able to generate a seal when put in contact with another suitable thermoplastic material under the appropriate conditions such as when applying sufficient heating. Suitable heating can be achieved by induction heating or ultrasonic heating or other heating means.

A second step in the manufacturing method is that of moulding the closure device 10 onto the first side of the packaging material. As described in relation to the various embodiments above said closure device 10 comprises a first closure part 16 and a second closure part 18. The moulding step comprises the sub-steps of arranging, on the first side of the packaging material, a first mould portion comprising at least a first mould cavity, arranging a second mould portion on the other side of the packaging material, positioned opposite the first mould portion, injecting a plastic melt into the first mould cavity, and removing the first and the second mould portions. The material of the closure device 10 is suitable for thermoplastic moulding, more specifically injection moulding, and may be polyethylene, polypropylene or another plastic suitable for injection moulding, for example polyethylene terephthalate. The first side of the packaging material is the side which will become the outer side of the packaging container 100, the first side having the décor layer. The heat of the melt will anchor or weld the closure device to the outer décor layer of the packaging material.

The first mould portion, or mould half has, as described above, at least one mould cavity. The first mould portion may comprise several cavities depending on the closure device. For instance, for the embodiment shown in FIG. 1 two mould cavities are suitable, one per isolated closure device part 16, 18. For instance, the embodiment shown in FIG. 3 may require four mould cavities due to the four separate closure device parts. The second mould portion, or mould half, is preferably flat and will support the packaging material such that it is not ruptured by the moulding pressure. The mould portions are arranged in register on opposite sides of the packaging material, and a melt is injected in at least one position into the first mould cavity. If there are several mould cavities several injection points may be used. During the injection process the flow rate will be essentially constant and the amount of plastic being injected will correspond to the volume of the mould cavity. The optimum flow rate may vary with design of the opening device, properties of the packaging material, properties of the plastic used, etc. yet in a presently operational embodiment the cycle time is less than about 300 ms, i.e., about three opening devices per second may be manufactured by a single mould. Cycle times of 250-1000 milliseconds are reasonable, including indexing of the packaging material.

The dimensions of the closure device 10 may be optimized to achieve an adequate foldability and reclosability of the packaging container 100 only and any surplus use of material may be avoided. In this way only a relatively small amount of plastic is needed, up to 1 gram. This has the beneficial effect that the time needed for injection is small, yet it also has the effect that the mould does not have to be closed for very long since the plastic will start to freeze (or solidify) immediately. The small amount of plastic vouches for that even if only a surface layer has started to freeze, this will be enough to retain the shape of the closure device 10 until it has fully frozen, which in turn implies that the mould will be opened basically as soon as the injection is finalized. An outermost skin layer of the plastic melt will freeze as soon as it contacts the walls of a mould cavity, or the outermost layer of the packaging material. For non-complex designs this vouches for that the mould may be opened as soon as it is filled. For more complex designs, e.g. designs incorporating steep edges or distinct ridges more time may have to be allocated for the plastic to freeze, such that the plastic is allowed to solidify from the skin and inwards before opening the mould. In this context it should be understood that the plastic will shrink (from the outside and inwards) as it freezes, and in a conventional injection molding process it is known to continue to inject plastic during the freezing, such that the finished detail is a replica of the mould cavity. It may also be important to realize that the longer the mould remains closed, the more heat will be transferred from the melt to the mould. This results in a need for installing a cooling arrangement, such as channels for leading cooling fluid through the mould portions. For the present invention such arrangements may not be necessary due to the inherently low cycle times.

Though there is no drawing of a mould or mould cavity the skilled person realizes that the shape of the mould cavity will correlate to the shape of the manufactured closure device (or rather—vice versa), and since the present invention is not directed to the shaping of mould cavities this will not be described any further. Also, injection moulding is a well-established technique not the least for some of the suggested materials: PE, PP and PET. Therefore a disclosure of an injection moulding process or features thereof is not considered essential for the skilled person to apply the present invention, and it is therefore omitted.

After moulding the packaging material comprises the closure device 10 and it is time to form the packaging material into packaging containers 100. The packaging material is formed into a tube by sealing overlapping longitudinal edges thereof into a seal 32. Either the packaging material is loaded into the filling machine as a continuous web which will be formed into several packaging containers, or the packaging material is loaded to the filling machine as blanks. In the latter case a sleeve-formed tube is formed by each blank.

The next steps are filling and sealing. In the case of a packaging material in the form of a blank, the sleeve-formed tube is in one end sealed along a transverse seal zone and thereby filled with the liquid or semi-liquid food product. The still open end is then sealed along a transverse seal zone.

In the case of a web-based filling machine, like for instance the Tetra Fino® Aseptic-type packaging machine the tube is continuously filled and sealed along transverse mutually apart seal zones 22 to form cushion-shaped packaging containers 100. In this case the method further comprises the step of separating the packaging containers from the tube by incisions in the seal zones 22.

Each transverse seal 22 is made such that the packaging material is folded around the second and third fold lines 24, 26 in the seal zones 22. Further, the position of the closure devices 10 in relation to the transverse sealing inductors are controlled such that a closure device is positioned on each packaging container and preferably in one corner of the finished packaging container, see for example FIG. 5. A such position facilitates pouring from the packaging container.

It is apparent to a person skilled in the art that with the advancement of technology, the basic idea may be implemented in various ways. The invention and its embodiments are thus not limited to the examples described above; instead they may vary within the scope of the claims.

For example, it has been described that the edges 16b and 18b are parallel to the transverse seal zone 22, however, alternatively, they may for example be perpendicular to the fold axis 14. Further it has been described that the edges 16c and 18 ca are parallel to the second fold axis 24. However, alternatively, they may for example be perpendicular to the fold axis 14. Further, it has been described that the first and second closure parts 16 and 18 in the first embodiment extend substantially all the way from the second fold axis 24 to the transverse seal zone 22. It may extend a substantial portion of the distance from the second fold axis 24 to the transverse seal zone, about more than 40 percent (%) of the distance, particularly 80 percent (%) of the distance. In a similar manner the first and second closure device parts 16 and 18 of the fourth embodiment extend a substantial portion of the distance from the second fold axis 24 to the third fold axis 26, about more than 40 percent (%) of the distance, particularly 80 percent (%) of the distance.

In FIG. 3 the first and second closure device parts 16, 18 are shown as equally long. In an alternative embodiment their lengths may for example be different from each other, for example the first closure device part 16 may be shorter and arranged centered with regard to the second closure device part 18. In an alternative embodiment the first closure device part 16 is split into two short portions (as in the embodiment in FIG. 3) and arranged at the far ends of a long single second closure device part 18.

1. Closure device for re-closing an opening on a packaging container for liquid or semi-liquid food, said opening having been initially opened within an opening area, said packaging container is provided with a first fold axis, wherein the closure device comprises at least a first closure device part and at least a second closure device part, wherein
the first closure device part is arranged on a first side of the first fold axis,
the second closure device part is arranged on a second side of the first fold axis,
the first closure device part is arranged between the opening area and the first fold axis,
the first and second closure device parts are provided with mutual lockable members such that the first and second closure device parts may be releasably locked to each other upon folding the packaging container along the first fold axis thereby re-closing the opening in the packaging container.

2. The closure device according to claim 1, wherein the first and second closure device parts are separated at least a distance (d) cross the first fold axis, to allow the closure device to be folded at the first fold axis.

3. The closure device according to claim 1, wherein the first closure device part is at least partly aligned along the first fold axis, and wherein the second closure device part is at least partly aligned along the first fold axis.

4. The closure device according to claim 1, wherein the first and second closure device parts are arranged on a first face of the packaging container.

5. The closure device according to claim 1, wherein the packaging container has a transverse seal zone and second and third fold axes, wherein the opening area and said first fold axis intersect the transverse seal zone and the second fold axis or the third fold axis.

6. The closure device according to claim 5, wherein the first fold axis is angled an angle with respect to the second or the third fold axes.

7. The closure device according to claim 1, wherein the first closure device part extends along the first fold axis a substantial portion of the distance from one of the second or third fold axes to the transverse seal zone.

8. The closure device according to claim 7, wherein the first closure part extend along more than 40% of the distance from one of the second or third fold axes to the transverse seal zone.

9. The closure device according to claim 5, wherein the second opening part extends along the first fold axis a substantial portion of the distance from one of the second or third fold axes to the transverse seal zone.

10. The closure device according to claim 9, wherein the second closure part extends along more than 40% of the distance from one of the second or third fold axes to the transverse seal zone.

11. The closure device according to claim 1, wherein the packaging container has a transverse seal zone and second and third fold axes, wherein the first fold axis intersects the second fold axis and the third fold axis.

12. The closure device according to claim 11, wherein the first fold axis is substantially parallel to the transverse seal zone.

13. The closure device according to claim 11, wherein one or both of the first and second closure device parts extend along the first fold axis from the second fold axis to the third fold axis.

14. The closure device according to claim 11, wherein the opening area is positioned between the transverse seal zone and the first closure device part.

15. The closure device according to claim 1, wherein the first closure device part has a hinge area which divides the first closure device part into two portions, wherein said hinge area has a hinge axis that intersects the first fold line.

16-34. (canceled)

35. The closure device according to claim 7, wherein the first closure part extends along more than 80% of the distance from one of the second or third fold axes to the transverse seal zone.

36. The closure device according to claim 9, wherein the second closure part extends along more than 80% of the distance from one of the second or third fold axes to the transverse seal zone
